(19) United States
(12) Patent Application Publication
(10) Pub. No.: US 2016/0079021 A1
(43) Pub. Date: Mar. 17, 2016

(54) COIL MODULE FOR ELECTROMAGNETIC SWITCHING DEVICE

(71) Applicant: WEG DRIVES & CONTROLS AUTOMAÇÃO LTDA,, Jaraguá do Sul (BR)

(72) Inventors: Andre DE BARROS ALBUQUERQUE, Jaraguá do Sul (BR); Juliano BERNARDI ROSSO, Jaraguá do Sul (BR); Leonardo Luiz VETORE, Jaraguá do Sul (BR)

(73) Assignee: WEG DRIVES & CONTROLS AUTOMAÇÃO LTDA,, Jaraguá do Sul (BR)

(21) Appl. No.: 14/889,959

(22) PCT Filed: May 21, 2013
(86) PCT No.: PCT/BR2013/000177

§ 371 Date: Nov. 9, 2015

(51) Int. Cl. H01H 50/02

(52) U.S. Cl. CPC H01H 50/02

(57) ABSTRACT

This application discloses an apparatus which may comprise an upper part including a main terminal, an auxiliary terminal, a movable core, a movable carrier, and contacts; and a lower part including an attachment base, a fixed armature, and a coil module. The coil module may include at least a pair of supports each with a cavity or a housing. Inside the cavity or the housing, at least one elastic element may connect a command terminal with a coil connection element.

### FIELD OF INVENTION

This invention refers to an electromagnetic switching device, such as a contactor, particularly a coil, module and its connection, which prevents connection problems facilitating the handling, storage and transportation thereof.

### BACKGROUND OF THE INVENTION

Generally, contactors are electromagnetic switching devices that conduct or interrupt the electrical current. They may be used according to the need, such as in motor starters, industrial illumination or power factor correction, among others. A construction relatively common consists of a magnetic set formed by one coil and two armatures, one fixed and other movable. The coil set presents a body in which is fixed a terminal, electrically connected to a wound wire that when powered generates a magnetic field able to magnetize the fixed and movable armatures, attracting one to another and consequently switching the movable contacts, which are joint to the movable armature through a carrier. In other direction, normally helical elastic elements known as springs are used to stimulate the contactor to open.

The contactors use in several fields of application pushes the search for new purposes, aiming the performance maximization and finished product durability. With the evolution of the connection configurations, the command terminal was presented in the state of the art nearest to the main and auxiliary terminals, and the most suitable manner of doing this connection is through any type of connection junction, avoiding welding or screws to make this connection, where generally the conception of two main assembly sets was raised, one having the main and auxiliary contacts, movable and fixed contacts, movable armature and carrier and the other set having the base, a fixed armature and coil. During the assembly phase, in this configuration, it is common the presence of undesired problems for positioning components when there is sequential or spare parts in this assembly, generating reworks in the manufacturing, in other way, there are difficulties when performing the maintenance operations in the final application; when the use off spare parts can be common, due to the maintenance environment not being suitable for handling small pieces; however, the conception of modular positioning is always desired. It should also be mentioned that the conducting terminals connection, connection elements and coil was always object of study, due to the characteristics inherent of this type of component, being subjects to vibrations and being found several manners of performing these electrical connections, as the desired configuration.

### Description of the State of the Art

In the state of the art, there are several types of contactors, classified as the required operational parameters, In the same way, there is a wide range of connections between the command terminal and the coil. Some applications consist of contactors provided with a command terminal fixed directly into the coil support, wherein the coil wire is found directly connected to the same. The main disadvantage in these systems is that it presents a geometric form of the command terminals supports distant in relation to the winding central shaft regarding what is desired, in function of the required geometric configuration, so these enable the external access for connection the power cables. This fact limits the performance in the winding process and requires an additional sizing of the housing region of said command terminals supports.

Alternatively, other possibilities consists in providing a flexible connection between the command terminal and the coil.

A traditional approach used in connections between the command terminal and the coil is disclosed in the patent document JP52022559, wherein it is described a contactor provided with a spring connection between the command terminal and the coil, in a way the spring is found attached to the coil under pressure. The assembly of this device comprises the coil positioning pressed against the spring in the support with limiting structure aid.

Other example of spring connection construction between coil and command terminal is disclosed in the patent U.S. Pat. No. 4,691,978, wherein it is disclosed a contactor provided with one accessory module for attenuating voltage peaks. In this case, the purpose of said module comes to be the positioning thereof in one recess of the contactor sidewall in a way to dispense additional hooks and connection structures.

Also, a third configuration is disclosed in the patent U.S. Pat. No. 5,059,930, describing an electromagnetic contactor having a fixed command terminal in its front region. Said terminal presents one extension connecting to a fixed flat spring in the coil. In this last document, there is a concern in trying to reduce or avoid errors transmission derived from the improper coupling of the crossbar with the casing, during its assembly.

However, a common disadvantage to the connection systems between coil-contactor terminals adopted in the documents

U.S. Pat. No. 4,691,978, U.S. Pat. No. 5,059,930 and JP52022559 previously mentioned is that the springs or structures with similar function remain exposed and, therefore, mechanically unprotected and susceptible to faults during the coil set transportation or in the assembly of said set to the contactor.

An attempt to overcome these problems is suggested in the patent JP 57076802, wherein it is disclosed a coil divided into two portions; in one of them, there is a concave housing for positioning a U-shaped armature and a circular housing for accommodating a cylinder spring without electrical function.

The contactor disclosed in the publication WO 2011012391 presents a command terminal that is arranged in the front region thereof. The command terminal presents an extension, whose end contemplates a corrugated profile connection pin supporting a helical spring connecting to a fixed flat terminal in the coil. This arrangement results in a spring, which ratio length/diameter presents a high value, leading the same to the possibility of glaze and damage the electrical connection.

### Object of the Invention

In this sense, aiming to overcome the disadvantages pertinent to the state of the art, this invention discloses a coil module having a connection interface by elastic elements between the element for coil connection and the command terminal for an electromagnetic switching device or contactor. Said coil module comprises a housing existent in its body that in turn houses a metallic elastic spiral conducting element (commonly known as “spring”), allowing this module to be processed, stocked, transported and installed without damages to the elastic element, besides facilitating maintenance operations.

Another advantage is the better capacity of connection between the command terminal and the coil connection element, which due to the fact of having elastic elements as interface supports better impacts and vibrations inherent to the contactor operation in different applications, when its conception prevents the presence of command terminals near to the main and auxiliary contacts. The elastic characteristic of the spring allows this stores mechanic energy and gives back without plastic deformation inside certain limits, allowing assembly variations between the upper and lower part of the contactor as well as possible variations in the command terminal extension length.

In other aspect of the present invention, it is disclosed an electromagnetic switching device provided with a coil module comprising one housing existent in its body housing a spring making electrical connection between the element for coil connection and the command terminal, in a way to ease maintenance negative points pertinent to assembly and operations. The negative points pertinent to assembly and maintenance of the connection terminals mentioned in the state of the art are properly contoured by the fact the module may function as a spare part, facilitating the interchangeability in maintenance operations and further avoiding that the user loses some component or performs an undue assembly.

### BRIEF DESCRIPTION OF THE FIGURES

FIG. 1 illustrates a perspective view showing the upper and lower regions of a contactor comprising the connection device.

FIG. 2 illustrates a perspective view of the coil module.

FIG. 3 illustrates a side view of the contactor, showing in partial cut the coil module arrangement.

FIG. 4 illustrates a cross-section of the contactor.

FIG. 5 illustrates the front cut extension of the elastic element connection with the command terminal and the connection element with the coil.

FIG. 6 illustrates a cut extension of a cross-section of the elastic element connection, presenting the locking shoulder in the connection element.

FIG. 7 illustrates an exploded view of the coil module, together with the command terminals (which do not belong to the coil module).

FIG. 8 illustrates a support extension with cavities and slots for connecting the coil module.

### DETAILED DESCRIPTION OF THE INVENTION

In the following, a preferred embodiment is disclosed of the coil module with a flexible connection interface and the electromagnetic switch presented in the figures from 1 to 8. It is important to note that the term “coil module” may be understood as a “coil set” or other term and it must not be understood as limiting or restrictive regarding the object now disclosed.

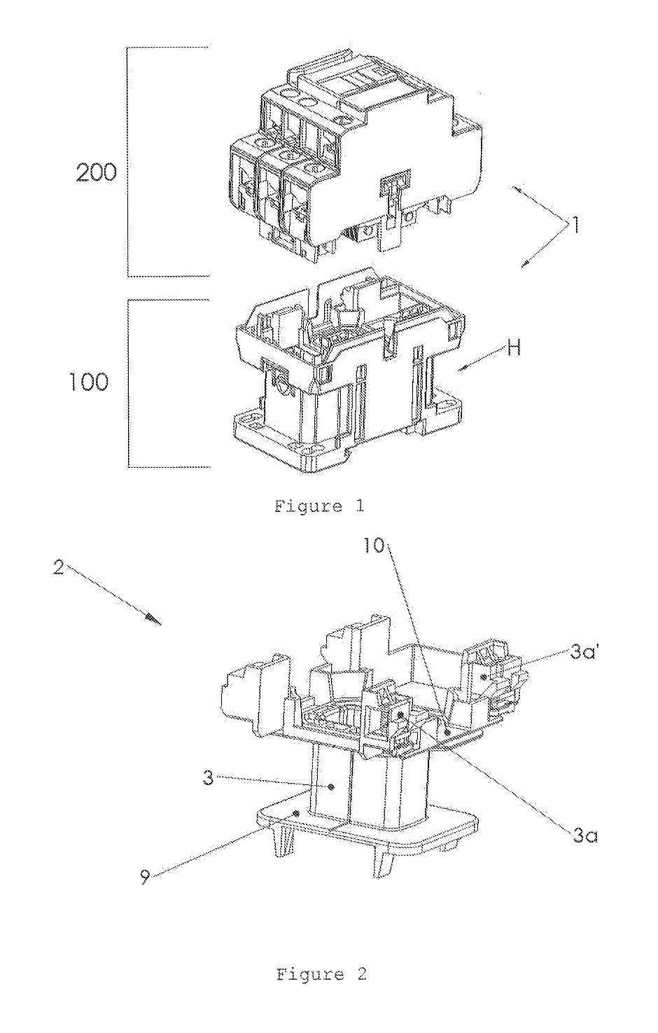

For reference purposes and having as base FIG. 1; the contactor (1) in a preferred construction is subdivided into two portions, upper (200) and lower (100). The upper part (200) comprises a plurality of main and auxiliary terminals, movable core, movable carrier and contacts, among others. It also may be seen in the FIG. 1, an attachment base (H), a fixed armature and a coil module (2), which forms the lower part (100). The contactor (1) is formed by an assembly performed through the upper part (200) and the lower part (100), joined by means of engagements known as “snap-fits”.

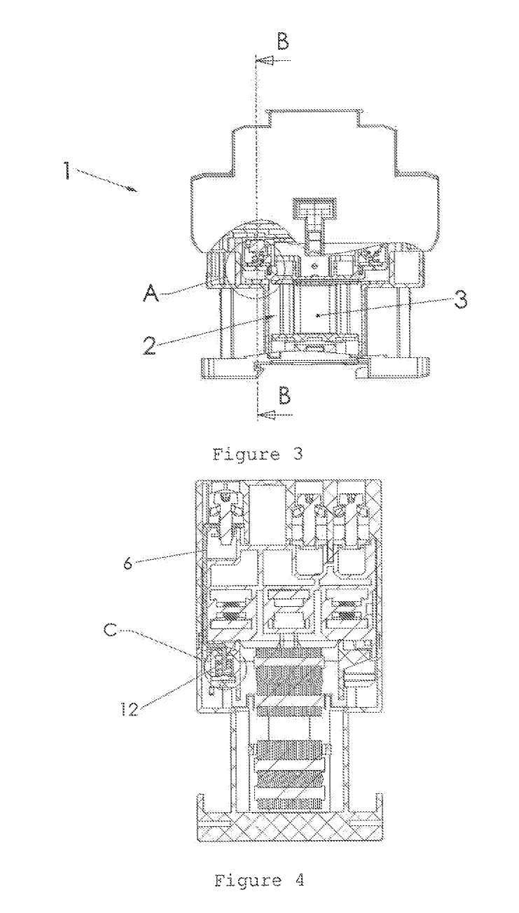

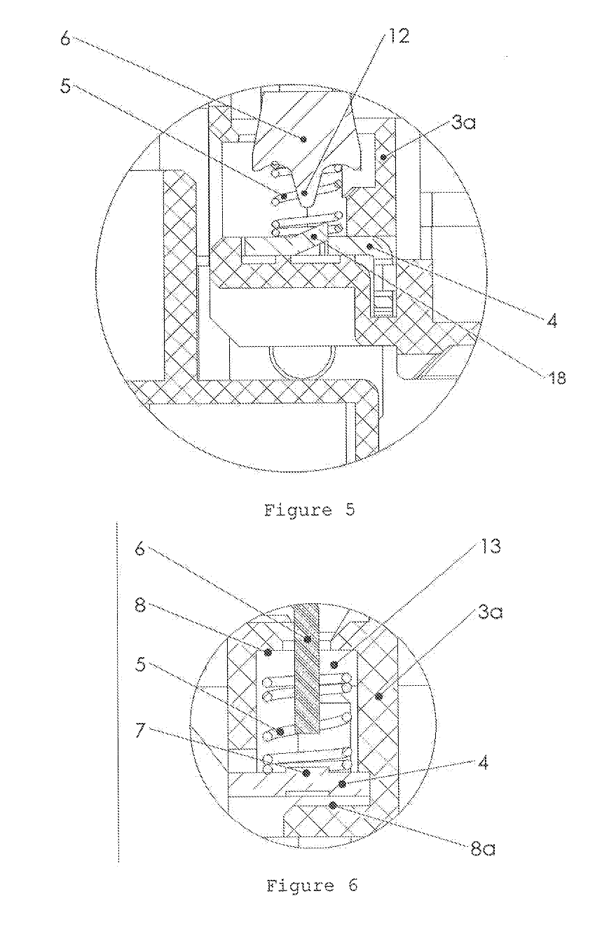

FIG. 2 illustrates the coil module (2), wherein a support base (9) may be noted supporting a central body (3) that, in turn, will support a second support base (10) parallel to the support base (9); both bases (9) and (10) together with the central body (3) support the winding (not illustrated). Over the support base surface (10), at least one pair of supports (3a, 3a′) is protruded. Each one of the supports (3a, 3a′) is arranged on one of the support base (10) ends in which each one of said supports (3a) or (3a′) comprise one cavity or housing (13), as can be noted in the FIG. 6. At least in two cavities or housings (13) of the supports (3a, 3a′), connections between command terminals (6,6′) and elements for coil connection (4, 4′) joined by the elastic elements (5,5′) are performed, as can be seen in the FIG. 4 (cross-section plan B-B of the FIG. 3 and also in the FIGS. 5 to 7).

FIG. 3 illustrates the contactor (1) positioning with the internalized coil module (2). In this configuration, the coil module (2) is assembled into the lower region (100) of said contactor (1), being interchangeable in assembly, disassembly and maintenance steps. The coil module (2), corresponding to a coil set, connection elements (4, 4′), elastic elements (5, 5′) and cavities or housings (13) and its connection with the command terminals (6, 6′) will be better understood from the following description.

FIG. 4 represents a contactor (1) cross-section where the command terminal (6, 6′) is presented in a way to conduct the current path to the coil module (2) and further has an indication of extension C, better viewed in the FIG. 6.

In FIG. 5, there is a cut expanded view of the region A indicated in FIG. 3, wherein the positioning of command terminals (6, 6′) and the fitting structures (12, 12′) are seen in the support (3a), Which will position the elastic elements (5, 5′), compressing and conducting energy to the elements for coil connection base (4, 4′), which preferably presents a ramp (18) in the shoulder (7) to ease the positioning insertion and locking of the elastic elements (5, 5′); which are connected finally through the modules for coil connection (4, 4′) to the winding end (not represented) of the coil module (2).

In FIG. 6, there is an expanded view of the portion C, indicated an FIG. 4. The coil connection element (4) base linked with the elastic element (5) protrudes a shoulder (7) and a face (8) opposed to the inner base (8a) in the housing (13) of the support (3a), allowing its locking after the assembly. The face (8) will allow the command terminal (6, 6′) connection together with the corresponding elastic element (5, 5′), through an upper opening (15), showed in the FIG. 8). The housing (13) of support (3a) is used to perform this connection, previously presented, has an inner base (8a) arranged adjacent to the element for coil connection (4) base, the face (8) opposed to the connection element (4) and the inner base (8a).

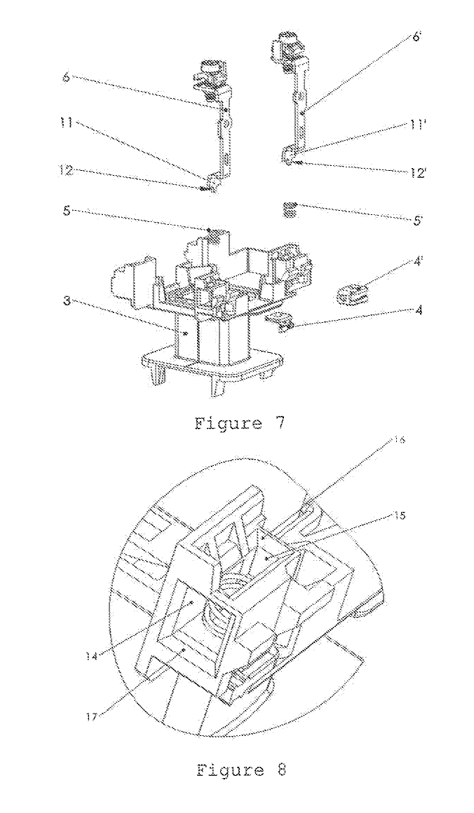

FIG. 7 illustrates a partially exploded view of the coil module (2) components complementing the FIGS. 4 and 5 where it is also required the pair of command terminals (6, 6′) strips, which present lowered ends, which in its cross-section profile viewed in the FIG. 4, forms a folded profile (11, 11′).

From the lower end of said folded structures of the command terminals strips (6 and 6′) tapering and seating structures (12, 12′) are protruded, allowing the elastic elements (5 and 5′) fitting to the upper region (100). Preferably, the elastic elements (5, 5′) must be helical but may present variations as for example telescopic types or others. In the same way, the elements for coil connection (4, 4′) may present different connection configurations with the coil, being by welding or snap-fits, of “mag-mate” type for example among others. Further considering the FIG. 7, the command terminals (6, 6′) preferably are found arranged in parallel one each other, and designed perpendicularly regarding the support base (10) in the upper region (200) of the contactor (1).

FIG. 8 refers to a coil module (2) extension where, to ease the elastic elements (5, 5′) insertion into the opening (14), it was foreseen a chamfer or rounding radius (17). In the same way, it can be seen in the assembly region that will allow the terminal de coil (6 and 6′) connection an opening (15) through the face (8), with a preferably rectangular or similar shape, having also a chamfer or rounding radius (16).

The coil module and the electromagnetic switching device previously described may be applied in the contactors construction; however, it must be understood that the embodiments disclosed do not represent thoroughly all the incorporations pertinent to the invention now disclosed. Any structural and functional details described must not be interpreted as limiting but as a guiding base for the purposed invention, in which one person skilled in the art may adequate to the construction, according to other categories as the specification.

1. An apparatus for an electromagnetic switching device, comprising:
an upper part including a main terminal, an auxiliary terminal, a movable core, a movable carrier, and contacts; and
a lower part including an attachment base, a fixed armature, and a coil assembly, wherein:
the coil assembly includes at least a pair of supports each with a cavity or a housing, and
inside each of the cavity or the housing, at least one elastic element connects a command terminal with a coil connection element.

2. The apparatus of claim 1, wherein the coil connection element includes a protruded shoulder contacting the at least one elastic element and a protruded face opposite to an inner base of one of the supports.

3. The apparatus of claim 2, wherein the protruded shoulder includes a ramp for inserting and locking the at least one elastic element.

4. The apparatus of claim 1, wherein the supports include a side opening for inserting the at least one elastic element.

5. The apparatus of claim 4, wherein the side opening includes a chamfer or rounding radius.

6. The apparatus of claim 1, wherein the supports include an upper opening giving access to connect with the at least one elastic element.

7. The apparatus of claim 6, wherein the upper opening includes a chamfer or rounding radius.

8. The apparatus of claim 1, wherein the command terminal is tapered and includes a seating for the at least one elastic element at the end of the command terminal.
